(19) United States
(12) Patent Application Publication
(10) Pub. No.: US 2026/0210272 A1
(43) Pub. Date: Jul. 23, 2026

(54) TWIN SCROLL TURBINE HOUSING

(71) Applicants: GARRETT MOTION TECHNOLOGY (SHANGHAI) CO, LTD., Pudong New Area, Shanghai (CN); GARRETT MOTION TECHNOLOGY (WUHAN) CO., LTD., Wuhan, Hubei (CN)

(72) Inventors: Penny LI, Shanghai (CN); John GONG, Shanghai (CN)

(73) Assignees: Penny LI, Pudong New Area, Shanghai (CN); GARRETT MOTION TECHNOLOGY (SHANGHAI) CO, LTD., Pudong New Area, Shanghai (CN); GARRETT MOTION TECHNOLOGY (WUHAN) CO., LTD., Wuhan, Hubei (CN)

(21) Appl. No.: 19/137,816

(22) PCT Filed: Nov. 20, 2023
(86) PCT No.: PCT/CN2023/132610

§ 371 Date: Jun. 11, 2025

(30) Foreign Application Priority Data
Dec. 12, 2022 (CN) 202211589214.8

(51) Int. Cl. F01D 25/24

(52) U.S. Cl. CPC F01D 25/24; F05D 2230/10

(57) ABSTRACT

A turbine housing can include a first scroll having a first scroll inlet; a second scroll having a second scroll inlet; a divider wall disposed between the first scroll and the second scroll, where the divider wall includes a machined divider wall tip at an inner perimeter that defines a first outlet throat of the first scroll and a second outlet throat of the second scroll, where the divider wall includes a first planar annular machined surface that defines a portion of the first scroll and that transitions to the machined divider wall tip at a first angle and a second planar annular machined surface that defines a portion of the second scroll and that transitions to the machined divider wall tip at a second angle, where the first angle and the second angle define a cross angle, and where the cross angle is greater than 25 degrees and less than 65 degrees.

### CROSS-REFERENCE TO RELATED APPLICATIONS

This application is a U.S. National-Stage entry under 35 U.S.C. § 371 based on International Application No. PCT/CN2023/132610, filed Nov. 20, 2023, which was published under PCT Article 21(2) and which claims priority to Chinese Application No. CN202211589214.8, filed Dec. 12, 2022, which are all hereby incorporated in their entirety by reference.

### TECHNICAL FIELD

Subject matter disclosed herein relates generally to turbine housings.

### BACKGROUND

A turbocharger can increase output of an internal combustion engine. A turbocharger can include an exhaust turbine assembly that can receive exhaust gas from cylinders of an internal combustion engine. Exhaust may be directed to a turbine wheel such that energy may be extracted, for example, to drive a compressor wheel of a compressor assembly. A turbine housing may be part of a turbocharger or may be utilized for one or more other purposes, whether as part of an internal combustion engine or another type of engine. In addition, other objects, desirable features and characteristics will become apparent from the subsequent summary and detailed description, and the appended claims, taken in conjunction with the accompanying drawings and this background.

### BRIEF DESCRIPTION OF THE DRAWINGS

The present disclosure will hereinafter be described in conjunction with the following drawing figures, wherein like numerals denote like elements, and:

FIG. 1 is a diagram of an example of a turbocharger and an internal combustion engine along with a controller;

FIGS. 2A, 2B and 2C are views of examples of turbocharger related equipment;

FIGS. 3A and 3B are views of an example of a turbine housing;

FIG. 4 is a cross-sectional view of the example of the turbine housing of FIGS. 3A and 3B;

FIG. 5 is a cross-sectional view of an example of a divider wall of a turbine housing;

FIG. 6 is a cross-sectional view of an example of a divider wall of a turbine housing;

FIG. 7 is a series of examples of profiles of a divider wall of a turbine housing;

FIG. 8 is an example of a machining tool for forming features of a divider wall; and

FIG. 9 is an example of a machining tool for forming features of a divider wall.

### DETAILED DESCRIPTION

The following detailed description is merely exemplary in nature and is not intended to limit the present disclosure or the application and uses of the present disclosure. Furthermore, there is no intention to be bound by any theory presented in the preceding background of the present disclosure or the following detailed description. Moreover, it is contemplated that, in various non-limiting embodiments, it is to be appreciated that all numerical values as provided herein, save for the actual examples, are approximate values with endpoints or particular values intended to be read as “about” or “approximately” the value as recited.

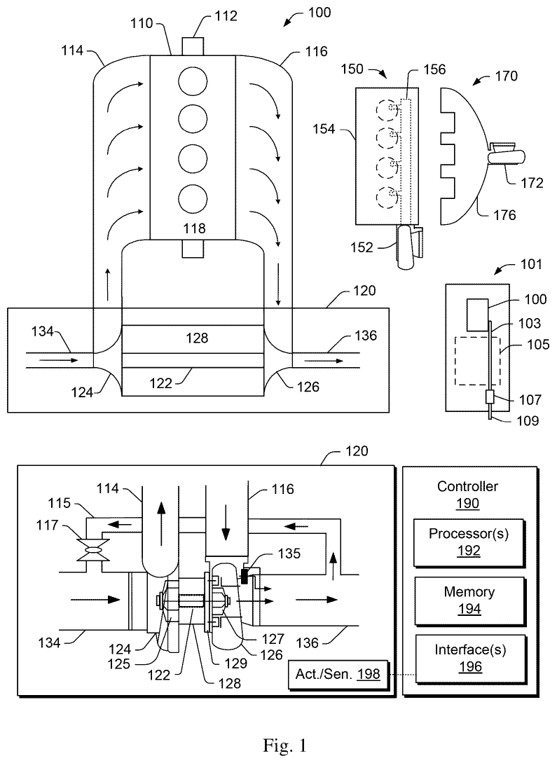

Turbochargers are frequently utilized to increase output of an internal combustion engine. Referring to FIG. 1, as an example, a system 100 can include an internal combustion engine 110 and a turbocharger 120. As shown in FIG. 1, the system 100 may be part of a vehicle 101 where the system 100 is disposed in an engine compartment and connected to an exhaust conduit 103 that directs exhaust to an exhaust outlet 109, for example, located behind a passenger compartment 105. In the example of FIG. 1, a treatment unit 107 may be provided to treat exhaust (e.g., to reduce emissions via catalytic conversion of molecules, etc.).

As shown in FIG. 1, the internal combustion engine 110 includes an engine block 118 housing one or more combustion chambers that operatively drive a shaft 112 (e.g., via pistons) as well as an intake port 114 that provides a flow path for air to the engine block 118 and an exhaust port 116 that provides a flow path for exhaust from the engine block 118.

The turbocharger 120 can act to extract energy from the exhaust and to provide energy to intake air, which may be combined with fuel to form combustion gas. As shown in FIG. 1, the turbocharger 120 includes an air inlet 134, a shaft 122, a compressor housing assembly 124 for a compressor wheel 125, a turbine housing assembly 126 for a turbine wheel 127, another housing assembly 128 and an exhaust outlet 136. The housing assembly 128 may be referred to as a center housing assembly as it is disposed between the compressor housing assembly 124 and the turbine housing assembly 126. The shaft 122 may be a shaft assembly that includes a variety of components. The shaft 122 may be rotatably supported by a bearing system (e.g., journal bearing(s), rolling element bearing(s), etc.) disposed in the housing assembly 128 (e.g., in a bore defined by one or more bore walls) such that rotation of the turbine wheel 127 causes rotation of the compressor wheel 125 (e.g., as rotatably coupled by the shaft 122). As an example a center housing rotating assembly (CHRA) can include the compressor wheel 125, the turbine wheel 127, the shaft 122, the housing assembly 128 and various other components (e.g., a compressor side plate disposed at an axial location between the compressor wheel 125 and the housing assembly 128).

In the example of FIG. 1, a variable geometry assembly 129 is shown as being, in part, disposed between the housing assembly 128 and the housing assembly 126. Such a variable geometry assembly may include vanes or other components to vary geometry of passages that lead to a turbine wheel space in the turbine housing assembly 126. As an example, a variable geometry compressor assembly may be provided.

In the example of FIG. 1, a wastegate valve (or simply wastegate) 135 is positioned proximate to an exhaust inlet of the turbine housing assembly 126. The wastegate valve 135 can be controlled to allow at least some exhaust from the exhaust port 116 to bypass the turbine wheel 127. Various wastegates, wastegate components, etc., may be applied to a conventional fixed nozzle turbine, a fixed-vaned nozzle turbine, a variable nozzle turbine, a twin scroll turbocharger, etc. As an example, a wastegate may be an internal wastegate (e.g., at least partially internal to a turbine housing). As an example, a wastegate may be an external wastegate (e.g., operatively coupled to a conduit in fluid communication with a turbine housing).

In the example of FIG. 1, an exhaust gas recirculation (EGR) conduit 115 is also shown, which may be provided, optionally with one or more valves 117, for example, to allow exhaust to flow to a position upstream the compressor wheel 125.

FIG. 1 also shows an example arrangement 150 for flow of exhaust to an exhaust turbine housing assembly 152 and another example arrangement 170 for flow of exhaust to an exhaust turbine housing assembly 172. In the arrangement 150, a cylinder head 154 includes passages 156 within to direct exhaust from cylinders to the turbine housing assembly 152 while in the arrangement 170, a manifold 176 provides for mounting of the turbine housing assembly 172, for example, without any separate, intermediate length of exhaust piping. In the example arrangements 150 and 170, the turbine housing assemblies 152 and 172 may be configured for use with a wastegate, variable geometry assembly, etc.

In FIG. 1, an example of a controller 190 is shown as including one or more processors 192, memory 194 and one or more interfaces 196. Such a controller may include circuitry such as circuitry of an engine control unit (ECU). As described herein, various methods or techniques may optionally be implemented in conjunction with a controller, for example, through control logic. Control logic may depend on one or more engine operating conditions (e.g., turbo rpm, engine rpm, temperature, load, lubricant, cooling, etc.). For example, sensors may transmit information to the controller 190 via the one or more interfaces 196. Control logic may rely on such information and, in turn, the controller 190 may output control signals to control engine operation. The controller 190 may be configured to control lubricant flow, temperature, a variable geometry assembly (e.g., variable geometry compressor or turbine), a wastegate (e.g., via an actuator), an electric motor, or one or more other components associated with an engine, a turbocharger (or turbochargers), etc. As an example, the turbocharger 120 may include one or more actuators and/or one or more sensors 198 that may be, for example, coupled to an interface or interfaces 196 of the controller 190. As an example, the wastegate 135 may be controlled by a controller that includes an actuator responsive to an electrical signal, a pressure signal, etc. As an example, an actuator for a wastegate may be a mechanical actuator, for example, that may operate without a need for electrical power (e.g., consider a mechanical actuator configured to respond to a pressure signal supplied via a conduit).

An internal combustion engine such as the engine 110 of FIG. 1 may generate exhaust gas with pulsating flow. In so-called constant-pressure turbocharging (e.g., Stauaufladung), an exhaust gas manifold of sufficiently large volume may act to damp out mass flow and pressure pulses such that flow of exhaust gas to a turbine is relatively steady. Another approach, referred to as pulse turbocharging (e.g., Stoβaufladung), may aim to utilize kinetic energy of exhaust gas as it exits cylinder exhaust ports. For example, relatively short, small-cross section conduits may connect each exhaust port to a turbine so that much of the kinetic energy associated with the exhaust blowdown can be utilized. As an example, suitable groupings of different cylinder exhaust ports may organize exhaust gas pulses such that they are sequential, for example, with minimal overlap. In such a manner, exhaust gas flow unsteadiness may be held to an acceptable level. As an example, decisions as to implementation of constant-pressure or pulse turbocharging may depend on one or more factors such as, for example, power demands, efficiency demands, fuel type, number of cylinders, cylinder/stroke volume, engine size, etc.

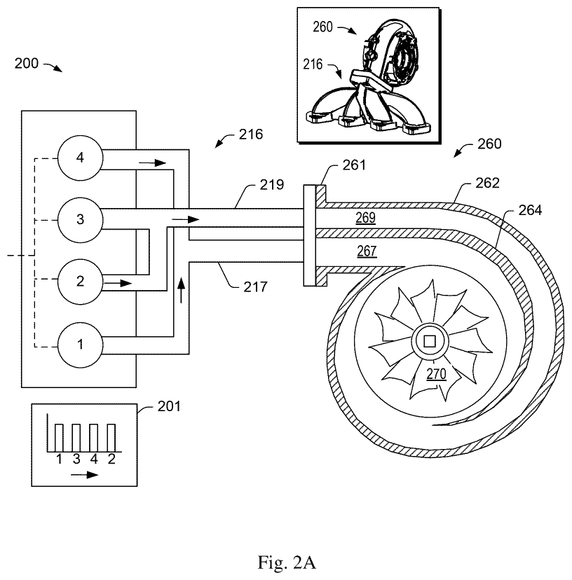

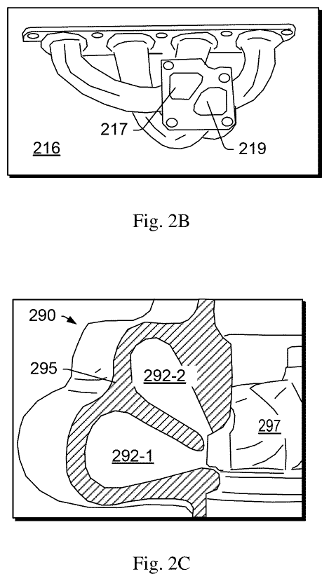

FIG. 2A shows an example of a system 200 that includes a four cylinder internal combustion engine with a firing order 201, for example, consider a firing order 1-3-4-2. As shown, a manifold 216 (e.g., or manifolds) may define exhaust gas flow paths that can direct exhaust gas from the cylinders of the internal combustion engine to a turbine assembly 260, which can, at least in part, house a turbine wheel 270. As shown in FIG. 2A, the turbine assembly 260 includes a flange 261, an outer wall 262 and an inner wall 264 where the outer wall 262 and the inner wall 264 define exhaust volute flow paths 267 and 269. The path 267 may receive exhaust from a flow path 217 in communication with cylinders 1 and 4 and the path 269 may receive exhaust from a flow path 219 in communication with cylinders 2 and 3.

FIG. 2B shows an example of the manifold 216 as including the two flow paths 217 and 219. As an example, the manifold 216 may be considered a divided manifold that separates flow of exhaust from cylinders whose cycles may interfere with one another (e.g., as to exhaust pulse energy). For example, on a four-cylinder engine with firing order 1-3-4-2, cylinder #1 is ending its expansion stroke and opening its exhaust valve while cylinder #2 still has its exhaust valve open (cylinder #2 is in its overlap period). In an undivided exhaust manifold, a pressure pulse from cylinder #1's exhaust blowdown event may be more likely to contaminate cylinder #2 with high pressure exhaust gas, which can impact performance of cylinder #2's (e.g., ability to breathe properly) and diminish pulse energy that may have been better utilized in by a turbine. As an example, a proper grouping for the aforementioned engine may keep complementary cylinders grouped together (e.g., exhaust of cylinders #1 and #4 as one complementary group and cylinders #2 and #3 as another complementary group). Such an approach may better utilize exhaust pulse energy and, for example, improve turbine performance (e.g., increase boost more rapidly).

Referring to FIG. 2C, a turbine assembly 290 is shown that includes volutes 292-1 and 292-2 with a divider wall 295 along with a turbine wheel 297. The turbine assembly 290 differs from the turbine assembly 260 in that the volutes 292-1 and 292-2 span a common range of angles about the turbine wheel 297.

In FIG. 2A, the walls 262 and 264 may be walls of a double-channel turbine housing where the paths 267 and 269 are radially adjacently formed channels. As shown, the paths 267 and 269 run in a substantially spiral form with respect to the turbine wheel 270.

As shown, the paths 267 and 269 are of different lengths on account of their geometric arrangement and may accordingly have different gas volumes, for example, with the length of the path 269 being greater than that of the path 267.

While an internal combustion engine with four cylinders is illustrated in FIG. 2A, one or more other engine types and/or numbers of cylinders (for example in-line six cylinder engines, V8 engines, V6 engines, six-cylinder boxer engines) may be employed.

In FIG. 2A, the path 217 may be defined by a first manifold exhaust-gas path length and the path 219 may be defined by a second manifold exhaust-gas path length. In the example of FIG. 2A, the first manifold exhaust-gas path 217 has a length that is longer than that of the second exhaust-gas path 219.

As shown in FIG. 2A, the first manifold path 217 is in communication with the first path 267 while the second manifold path 219 is in communication with the second path 269 such that the longer exhaust-gas path length can be connected to the shorter path of the turbine assembly. Such an approach may aim to “equalize” overall path lengths. As an example, a double-channel (e.g., dual path) turbine housing with considerably different channels may be “equalized” via a manifold geometry with likewise different channels. As an example, a combination of short and long individual paths (e.g., channels) of a turbine housing and manifold may act to obtain approximately equal overall paths.

As an example, a twin scroll turbine housing can include a divider wall that can be defined in part by a divider wall ratio (DWR). As an example, a smaller DWR can increase engine low end pulsation usage (torque) but may tend to worsen engine high end brake specific fuel consumption (e.g., decreased turbo efficiency). As an example, a twin scroll turbine housing can include a machined divider tip that includes annular flats (e.g., planar annular surfaces) that can improve efficiency and provide a suitable balance for turbo efficiency and flow separation. In such an example, the twin scroll turbine housing may also include one or more machined scroll nozzles (e.g., throats) and/or a diffuser section with one or more machined surfaces where the diffuser section receives flow from two scroll nozzles (e.g., throats).

As to DWR, it can be defined as the radius or diameter of an inner perimeter of a divider wall and the outer radius or diameter of a turbine wheel. As such, the DWR is greater than 1 to provide clearance for rotation of a turbine wheel, noting that factors such as Poisson's ratio, thermal effects, etc., may be taken into account. In various instances, DWR may be in a range from 1.005 to 1.2, and may be greater than 1.2. In various instances, for example, where the DWR tends to be greater, spacing of the divider wall from the turbine wheel can make it possible for a divider wall to be formed by conventional casting, optionally without machining.

However, for a smaller DWR, machining of a cast turbine housing can be utilized to help assure precise clearance between a divider wall and a turbine wheel.

As an example, a smaller DWR may be selected and utilized with a machine divider wall tip to maintain performance level. For example, consider a DWR reduction from 1.1 to less than 1.05. In such an example, a twin scroll turbine housing can have improved flow/pressure separation (e.g., by approximately 2 percent or more). As an example, machining may be implemented in a cost effective manner, for example, by utilizing a machining tool that can rapidly form a desired divider wall tip shape. Such a tool may include one or more surfaces that can be utilized to grind material of a cast turbine housing to shape, size, etc., one or more surfaces of the cast turbine housing.

In various trials, DWRs of 1.1, 1.05 and 1.015 were examined where, without a particularly shaped divider wall tip, efficiency decreased with respect to decreasing DWR. However, with a particularly shaped divider wall tip, efficiency was maintained at a DWR of 1.05 and substantially improved at a DWR of 1.015. Further, corrected mass flow rate was also improved with the particularly shaped divider wall tip. Thus, the particularly shaped divider wall tip improved performance and flow characteristics related to pulse separation.

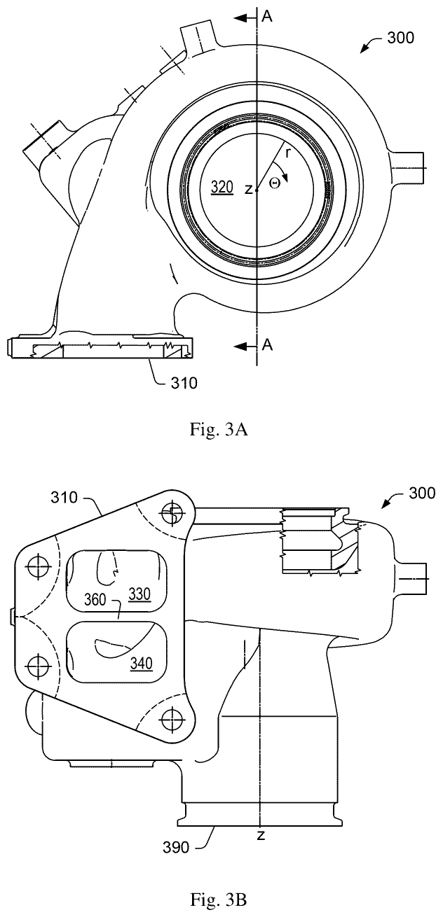

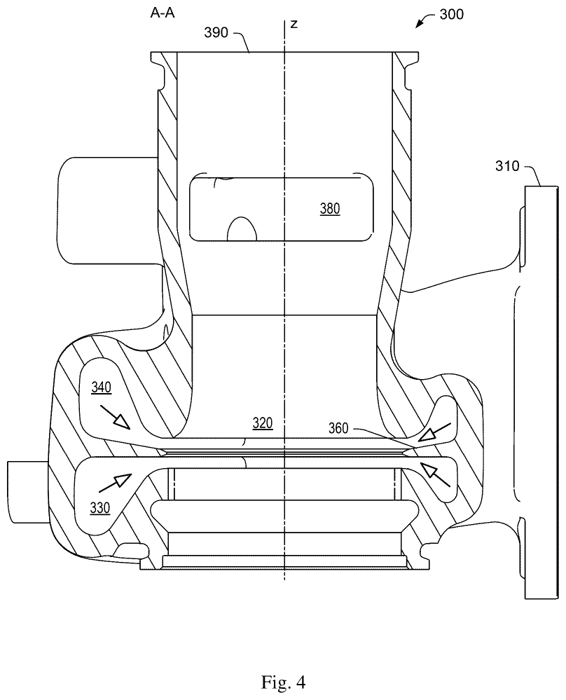

FIG. 3A and FIG. 3B show views of an example of a turbine housing 300 that includes an inlet 310, an outlet 390, a turbine wheel space 320, scrolls 330 and 340, and a divider wall 360 that, in part, defines each of the scrolls 330 and 340. In the example of FIG. 3A and FIG. 3B, a cylindrical coordinate system is shown with a central z-axis as an axial coordinate, a radial coordinate and an azimuthal coordinate (D). One or more features of the turbine housing 300 may be defined by the coordinates of the cylindrical coordinate system.

As explained, one of the scrolls 330 and 340 can receive exhaust gas from a first set of cylinders and another one of the scrolls 330 and 340 can receive exhaust gas from a second set of cylinders. In such an example, pulsations from the cylinders can be transmitted via exhaust flow to the scrolls 330 and 340, which direct the exhaust flow to the turbine wheel space 320 where a turbine wheel can be positioned and rotatably driven by the exhaust flow. Pulsations, depending on peaks, valleys, strength, timing, etc., may cause undesirable flow patterns at the two outlets of two adjacent scrolls. For example, a strong peak at a first scroll outlet may coincide with a valley at a second scroll outlet such that a portion of flow of the first scroll outlet is bent or otherwise directed toward the second scroll outlet. As an example, such undesirable flow may be addressed, at least in part, through use of a smaller DWR; noting that one or more nozzle shapes (e.g., throat shapes) and/or a diffuser section shape may be utilized to also, at least in part, address undesirable flow.

FIG. 4 shows a cross-sectional view along a line A-A (see FIG. 3A) of the turbine housing 300. As shown, the divider wall 360 has an inner perimeter at the turbine wheel space 320 where flow from the scrolls 330 and 340 is directed to the turbine wheel space 320. As shown by open headed arrows, flow can be directed from the scrolls 330 and 340 through annular throats that may angle flow toward a common plane, which may be defined by the inner perimeter of the divider wall 360 (see also, e.g., FIG. 2C). In the example of FIG. 4, the turbine housing 300 also includes a passage 380 that is at an axial position between the turbine wheel space 320 and the outlet 390, where the outlet 390 can be in fluid communication with an exhaust system that may provide for flow of exhaust to an external environment (e.g., via a silencer, a catalytic converter, etc.). In such an example, the passage 380 may provide for exhaust gas recirculation (EGR).

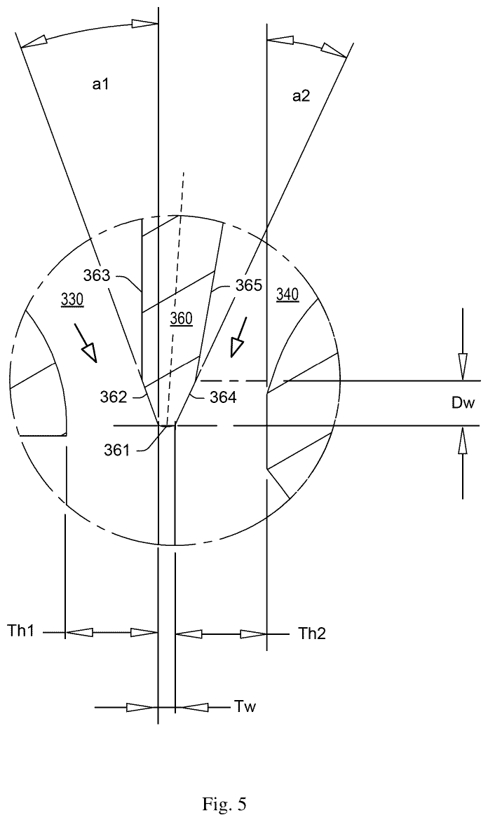

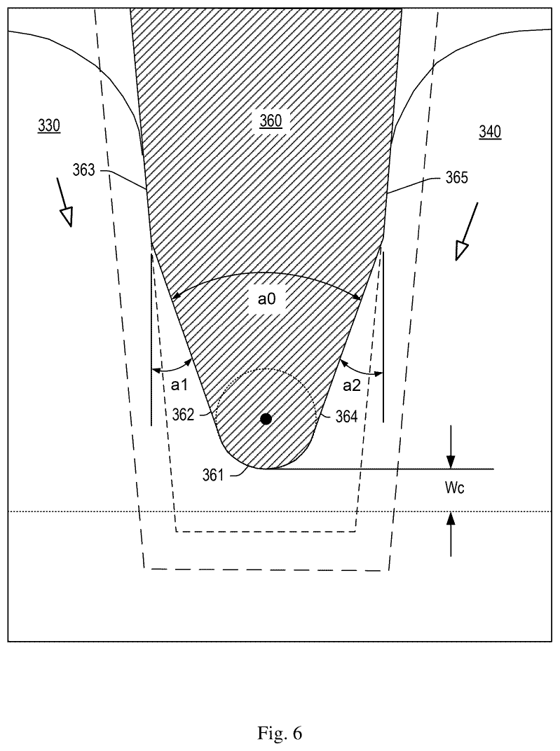

FIG. 5 shows an enlarged view of an example of the divider wall 360, including a divider wall tip 361 that forms an inner perimeter of the divider wall 360. As shown, the divider wall 360 includes a first planar annular surface 362 that transitions to a first scroll surface 363 of the first scroll 330 and a second planar annular surface 364 that transitions to a second scroll surface 365 of the second scroll 340. In such an example, transition points may be defined using one or more radii as may be measured from a rotational axis of a turbine wheel disposed in the turbine wheel space 320 or, for example, from a central axis of the turbine wheel space 320 that is to align with a turbine wheel rotational axis.

Various dimensions are shown in the example of FIG. 5, including axial throat widths Th1 for the scroll 330 and Th2 for the scroll 340 along with a divider wall tip width (e.g., axial height) Tw. In the radial direction, Dw indicates a dimension of the first planar annular surface 362 and the second planar annular surface 364, which may have a common dimension or differing dimensions. As shown, an angle al can define an angle of the first planar annular surface 362 with respect to a radial line that passes through the divider wall tip 361 and an angle a2 can define an angle of the second planar annular surface 364 with respect to a radial line that passes through the divider wall tip 361 or, for example, that is level with a throat wall of the second throat Th2 of the second scroll 340. As an example, the divider wall tip 361 may be shaped as appropriate, for example, using a circular shape, a parabolic shape, etc., where the divider wall tip 361 transitions to the first planar annular surface 362 to a side of the first scroll 330 and transitions to the second planar annular surface 364 to a side of the second scroll 340.

As shown in the example of FIG. 5, the divider wall 360 may be disposed at an angle as it approaches the divider wall tip 361. For example, consider an angle of approximately 1 degree to approximately 30 degrees as may be measured from a radial line passing through the divider wall tip 361 toward the second scroll 340. Such an angle may be due to space available, for example, less space may be available for the first scroll 330, compared to the second scroll 340, due to the connection of the turbine housing 300 to a center housing.

As shown in the example of FIG. 5, the throats Th1 and Th2 may be approximately equal and the angles al and a2 may be approximately equal. In the example of FIG. 5, the angle al may be approximately 20 degrees while the angle a2 may be approximately 25 degrees.

Referring again to the example of FIG. 4, which shows two views through the two scrolls 330 and 340, as each of the scrolls 330 and 340 decreases in cross-sectional area with respect to azimuthal angle about a central axis, some variation in direction of flow may occur, however, throat height may remain substantially constant (see, e.g., horizontal lines in FIG. 4 at the throats of the scrolls 330 and 340). In the example of FIG. 4, the divider wall 360 approaches the divider wall tip at a relatively constant angle. The throats of the scrolls 330 and 340 may be summed, in combination with the divider wall tip width (height) Tw to provide an overall throat width (height). For example, in FIG. 5, Th1, Th2 and Tw may be summed to provide an overall throat width (height) that directs flow to blades of a turbine wheel disposed in the turbine wheel space 320. As an example, an overall throat width (height) may be constant or, for example, may vary with respect to distance from a central axis (e.g., rotational axis of a turbine wheel). As an example, a diffuser section may be defined using at least a point where two throats (e.g., nozzles) meet. For example, a diffuser section may be defined using a radial dimension of the divider wall tip 361 and one or more other radial dimensions, for example, of a surface of the scroll 330 that extends to a smaller radius than the divider wall tip 361 and/or of a surface of the scroll 340 that extends to a smaller radius than the divider wall tip 361. Where a surface of a scroll is mentioned, it may be a surface of a turbine housing (e.g., one or more surfaces of a turbine housing can define a scroll, can define a throat or nozzle, can define a diffuser section, etc.).

FIG. 6 shows an example of the divider wall 360 as disposed between the scrolls 330 and 340 where the divider wall tip 361 has a circular cross-sectional profile (e.g., a circular arc) that transitions to the planar annular surfaces 362 and 364 on opposing sides, corresponding to the scrolls 330 and 340, respectively. As shown, the planar annular surfaces 362 and 364 transition to scroll surfaces 363 and 365, respectively, which define, in part, the scroll 330 and the scroll 340, respectively.

In the example of FIG. 6, dashed lines are shown to indicate material prior to machining. For example, a turbine housing may be cast with a divider wall region that forms an inner perimeter of the unmachined cast turbine housing. In such an example, the unmachined cast turbine housing can be machined to provide a desired clearance Wc between the finished divider wall tip 361 and an outer perimeter (e.g., blade radius) of a turbine wheel. In the example of FIG. 6, the divider wall 360 is formed from an unmachined cast turbine housing represented approximately by the small dashed line; whereas, the large dashed line may represent dimensions of another unmachined cast turbine housing. An amount of material, and dimensions thereof, may determine where one or more transitions occur with respect to, for example, the planar annular surfaces 362 and 364.

As an example, a planar annular surface may be at least approximately 2 mm in depth (see, e.g., Dw). As an example, angles a1 and a2 may be utilized to define a cross angle (see, e.g., a0 in FIG. 6), which may be, for example, in a range from approximately 25 degrees to approximately 65 degrees (e.g., optionally depending on DWR).

As to different turbine housings, casting can result in some geometry variation. As an example, machining tool can be designed for specific divider wall shape. In such an example, the machining tool may control DWR and make smooth divider wall ranges. As an example, a cross angle (see, e.g., a0) may be in a range from approximately 25 degrees to approximately 65 degrees (e.g., depending on DWR). As an example, casting stock for machining a divider wall tip can be greater than approximately 1 mm.

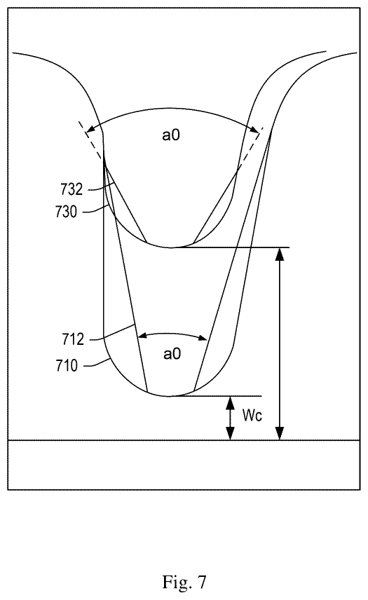

FIG. 7 shows some example profiles of example divider walls 710 and 730 with corresponding examples of finished, machined divider walls 712 and 732. As shown, a divider wall may be machined to achieve a desired clearance Wc with a turbine wheel. As an example, where a clearance is to be larger, a cross angle a0 may be larger.

As an example, a turbine housing may be formed from an iron alloy, other alloy or, for example, aluminum. As an example, a turbine housing may be suitable for use with one or more types of fuel engines (e.g., diesel, gas, hydrogen, etc.).

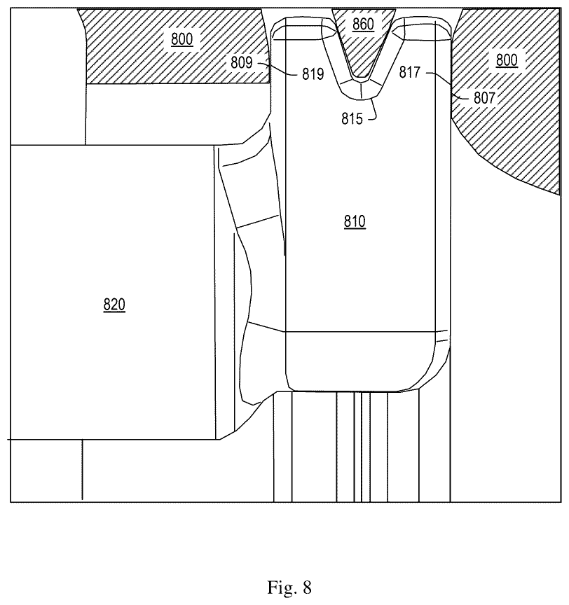

FIG. 8 shows an example of a machining tool 810 with respect to a turbine housing 800 that includes a divider wall 860. The machining tool 810 can include a shaft 820 and a cutting profile 815 that provides for machining the divider wall 860 to achieve a desired profile with two planar annular surfaces. As an example, the machining tool 810 may be rotated via the shaft 820 and moved about an inner perimeter of the divider wall 860 to form the desired profile.

In the example of FIG. 8, the machining tool 810 may also include one or more cutting surfaces 817 and 819, which may, for example, simultaneously cut material of the turbine housing 800. For example, consider the cutting surface 817 cutting a diffuser wall surface 807 and the cutting surface 819 cutting another diffuser wall surface 809. In such an example, the machining tool 810 may be used to form a nozzle width (e.g., axial nozzle height) and may be used to form a desired profile of the divider wall 860. Further, depending on the operation and/or features of the machining tool 810, it may be used to form a first nozzle shape of a first nozzle for a first scroll, a second nozzle shape of a second nozzle for a second scroll and a nozzle shape in a diffuser section that receives flow from the first nozzle and the second nozzle. As an example, the cutting surfaces 817 and 819 may be substantially parallel and spaced an axial distance from one another where the axial distance may depend on one or more features of a turbine wheel such as, for example, a blade height of a leading edge of a turbine wheel blade. As an example, the machining tool 810 may include surfaces that do not interfere with surfaces other than divider wall end surfaces. For example, the cutting surfaces 817 and 819 may be non-cutting surfaces and utilized to guide the cutting profile 815 and/or they may be spaced more closely together such that they do not contact the surfaces 807 and 809 of the turbine housing 800

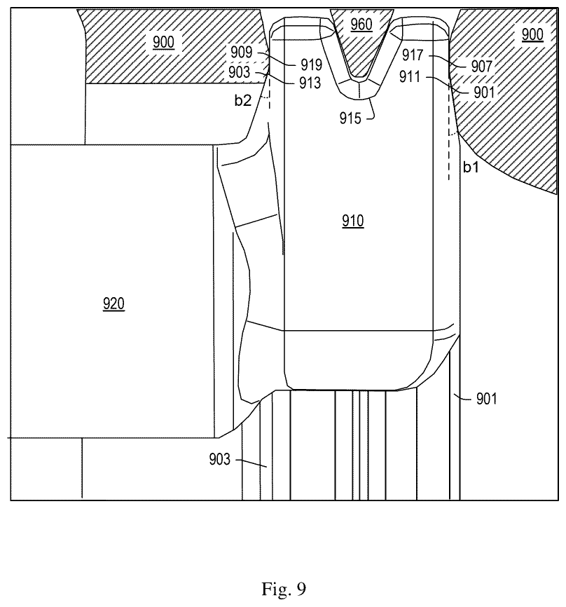

FIG. 9 shows an example of a machining tool 910 with respect to a turbine housing 900 that includes a divider wall 960. The machining tool 910 can include a shaft 920 and a cutting profile 915 that provides for machining the divider wall 960 to achieve a desired profile with two planar annular surfaces. As an example, the machining tool 910 may be rotated via the shaft 920 and moved about an inner perimeter of the divider wall 960 to form the desired profile.

In the example of FIG. 9, the machining tool 910 can also include one or more cutting surfaces 911, 913, 917 and 919, which may, for example, simultaneously cut material of the turbine housing 900. For example, consider the cutting surfaces 911 and 917 cutting diffuser wall surfaces 901 and 907 and the cutting surfaces 903 and 919 cutting other diffuser wall surfaces 903 and 919. In such an example, the machining tool 910 may be used to form a nozzle width (e.g., axial nozzle height) that may vary with respect to radial distance from a central axis such as, for example, a turbine wheel rotational axis of a turbine wheel disposed in a turbine wheel space where the machining tool 910 may also be used to form a desired profile of the divider wall 960.

As shown in the example of FIG. 9, the diffuser wall surface 901 can be a machined diffuser wall surface that transitions radially inwardly to a shroud surface of a turbine wheel space where the shroud surface may have a profile that depends on a shape of a turbine wheel blade (e.g., an outer edge between a leading edge and a trailing edge of the turbine wheel blade).

In the example of FIG. 9, the cutting surfaces 911 and 917 may be planar and set at different angles. For example, the cutting surface 917 may be at 0 degrees and the cutting surface 911 may be at an angle b1 with respect to 0 degrees (e.g., consider a range from 0.01 degree to 45 degrees). In the example of FIG. 9, the cutting surfaces 913 and 919 may be planar and set at different angles. For example, the cutting surface 919 may be at 0 degrees and the cutting surface 913 may be at an angle b2 with respect to 0 degrees (e.g., consider a range from 0.01 degree to 45 degrees). As an example, the angles b1 and b2 may differ or they may be equal. Such angles may be selected in a manner that depends on one or more features of a turbine wheel, for example, consider a blade height of a leading edge of a blade of a turbine wheel.

Further, depending on the operation and/or features of the machining tool 910, it may be used to form a first nozzle shape of a first nozzle for a first scroll, a second nozzle shape of a second nozzle for a second scroll and a nozzle shape in a diffuser section that receives flow from the first nozzle and the second nozzle. As an example, the cutting surfaces 917 and 919 may be substantially parallel and spaced an axial distance from one another and the cutting surfaces 911 and 913 may be diverging with respect to one another such that a diffuser section axial height (e.g., width) increases with decreasing radial distance from a central axis.

As an example, a machining tool may be utilized to form a turbine housing such as, for example, the turbine housing 800 of FIG. 8, the turbine housing 900 of FIG. 9, etc. As explained, a machining tool may be utilized to shape an end of a divider wall, may be utilized to shape one or more scroll nozzles (e.g., throats) and/or may be utilized to shape a diffuser section for two scroll nozzles (e.g., throats). In various examples, a machining tool may shape a turbine housing such that a distance between an outer perimeter of a turbine wheel and a tip of a divider wall is reduced, which may, for example, help to reduce risk of undesirable flow patterns of pulsating flows in adjacent scrolls.

As an example, a machining tool may be utilized to machine a divider wall of a cast turbine housing where machining reduces incidents of cross cracks. For example, cracks that may emerge may be radial cracks that extend predominantly in a radial direction.

As an example, a turbine housing may include one or more EGR features. For example, the turbine housing 300 of FIG. 4 can include one or more EGR features, which may include, for example, an EGR feature for flow of exhaust downstream the turbine wheel space 320 (see, e.g., the passage 380).

A scroll is a generally spiral passage that can be defined by a housing, which may be referred to as a scroll case. A scroll can direct exhaust gas flow from a single passage such as a pipe to an annular passage, which may be referred to as an annular nozzle (e.g., annular throat). For example, a scroll can direct exhaust gas from a manifold to a periphery of a turbine wheel via an annular nozzle (e.g., annular throat).

A scroll may be characterized by an area over radius ratio (A/R) (see, e.g., FIG. 3). A/R is defined as the inlet (or, for compressor housings, the discharge) cross-sectional area divided by the radius from a turbine centerline to the centroid of that area. As a scroll decreases in its cross-sectional flow area as it spirals radially inwardly from its inlet to its annular nozzle, both area and radius change. A/R can be selected based on various factors to help assure that it propels a turbine wheel in an effective manner. Selection of the appropriate A/R can help to optimize performance. For example, a too small A/R can bottleneck the exhaust gas and loose power, particularly in an upper region of the RPM powerband; whereas, a too large A/R can make a turbine slow to react to changes in exhaust gas flow.

As an example, a turbine housing can include a first scroll having a first scroll inlet; a second scroll having a second scroll inlet; a divider wall disposed between the first scroll and the second scroll, where the divider wall includes a machined divider wall tip at an inner perimeter that defines a first outlet throat of the first scroll and a second outlet throat of the second scroll, where the divider wall includes a first planar annular machined surface that defines a portion of the first scroll and that transitions to the machined divider wall tip at a first angle and a second planar annular machined surface that defines a portion of the second scroll and that transitions to the machined divider wall tip at a second angle, where the first angle and the second angle define a cross angle, and where the cross angle is greater than 25 degrees and less than 65 degrees. In such an example, the first planar annular machined surface can transition to a cast curved surface of the first scroll and the second planar annular machined surface can transition to a cast curved surface of the second scroll.

As an example, a first angle and a second angle of a machined divider wall can differ or, for example, they can be equal.

As an example, a turbine housing can include a diffuser section that includes at least one machined diffuser section surface, where the diffuser section is in fluid communication with a first outlet throat of a first scroll and a second outlet throat of a second scroll.

As an example, a machined divider wall tip can be machined to define a turbine wheel clearance. For example, consider a DWR value that can describe the clearance in a dimensionless manner.

As an example, a cross angle may depend on a turbine wheel clearance (e.g., and/or DWR) where the cross angle can increase with an increase in turbine wheel clearance.

As an example, a turbine housing can include a turbine wheel where a divider wall ratio (DWR) is less than or equal to 1.05. As an example, a divider wall ratio of a turbine housing and a turbine wheel can be less than 1.05. As an example, consider a turbine housing and a turbine wheel with a divider wall ratio that is approximately 1.015 (e.g., consider a range from 1.0075 to 1.0225).

As an example, a clearance between a machined divider wall tip and an outer perimeter or outer radius of a turbine wheel can be less than 2 mm. For example, consider a clearance that is less than 1 mm or, for example, a clearance that is approximately 0.5 mm (e.g., consider a range from 0.35 mm to 0.65 mm).

As an example, a method can include providing a cast turbine housing that includes a first scroll having a first scroll inlet, a second scroll having a second scroll inlet, and a divider wall disposed between the first scroll and the second scroll; and machining the divider wall to generate a machined divider wall tip at an inner perimeter that defines a first outlet throat of the first scroll and a second outlet throat of the second scroll and to generate a first planar annular machined surface that defines a portion of the first scroll, that transitions to the machined divider wall tip at a first angle, and a second planar annular machined surface that defines a portion of the second scroll, that transitions to the machined divider wall tip at a second angle, where the first angle and the second angle define a cross angle, where the cross angle is greater than 25 degrees and less than 65 degrees. In such an example, machining can utilize a machining tool with a head and a shaft where the head is rotatable responsive to rotation of the shaft. In such an example, the head can include a cutting profile that forms the machined divider wall tip, the first planar annular machined surface and the second planar annular machined surface.

As an example, a head can include at least one machining surface that forms a machined surface of a diffuser section of a turbine housing. Such a head can also include a cutting profile that forms a machined divider wall tip, a first planar annular machined surface and a second planar annular machined surface. As an example, a method may be utilized to form a turbine housing.

Although some examples of methods, devices, systems, arrangements, etc., have been illustrated in the accompanying Drawings and described in the foregoing Detailed Description, it will be understood that the example embodiments disclosed are not limiting, but are capable of numerous rearrangements, modifications and substitutions.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. A turbine housing comprising:
a first scroll having a first scroll inlet;
a second scroll having a second scroll inlet; and
a divider wall disposed between the first scroll and the second scroll, wherein the divider wall comprises a machined divider wall tip at an inner perimeter that defines a first outlet throat of the first scroll and a second outlet throat of the second scroll, wherein the divider wall comprises a first planar annular machined surface that defines a portion of the first scroll and that transitions to the machined divider wall tip at a first angle and a second planar annular machined surface that defines a portion of the second scroll and that transitions to the machined divider wall tip at a second angle, wherein the first angle and the second angle define a cross angle, and wherein the cross angle is greater than about 25 degrees and less than about 65 degrees.

2. The turbine housing of claim 1, wherein the first planar annular machined surface transitions to a cast curved surface of the first scroll and wherein the second planar annular machined surface transitions to a cast curved surface of the second scroll.

3. The turbine housing of claim 1, wherein the first angle and the second angle differ.

4. The turbine housing of claim 1, wherein the first angle and the second angle are equal.

5. The turbine housing of claim 1, comprising a diffuser section that comprises at least one machined diffuser section surface, wherein the diffuser section is in fluid communication with the first outlet throat and the second outlet throat.

6. The turbine housing of claim 1, wherein the machined divider wall tip is machined to define a turbine wheel clearance.

7. The turbine housing of claim 1, wherein the cross angle depends on the turbine wheel clearance and wherein the cross angle increases with an increase in turbine wheel clearance.

8. The turbine housing of claim 1, further comprising a turbine wheel wherein a divider wall ratio is less than or equal to about 1.05.

9. The turbine housing of claim 1, further comprising a turbine wheel wherein a divider wall ratio is less than about 1.05.

10. The turbine housing of claim 1, further comprising a turbine wheel wherein a divider wall ratio is approximately about 1.015.

11. A method comprising:
providing a cast turbine housing that comprises a first scroll having a first scroll inlet, a second scroll having a second scroll inlet, and a divider wall disposed between the first scroll and the second scroll; and
machining the divider wall to generate a machined divider wall tip at an inner perimeter that defines a first outlet throat of the first scroll and a second outlet throat of the second scroll and to generate a first planar annular machined surface that defines a portion of the first scroll, that transitions to the machined divider wall tip at a first angle, and a second planar annular machined surface that defines a portion of the second scroll, that transitions to the machined divider wall tip at a second angle, wherein the first angle and the second angle define a cross angle, wherein the cross angle is greater than about 25 degrees and less than about 65 degrees.

12. The method of claim 11, wherein the machining utilizes a machining tool with a head and a shaft wherein the head is rotatable responsive to rotation of the shaft.

13. The method of claim 12, wherein the head comprises a cutting profile that forms the machined divider wall tip, the first planar annular machined surface and the second planar annular machined surface.

14. The method of claim 11, wherein the head comprises at least one machining surface that forms a machined surface of a diffuser section of the turbine housing.

15. A turbine housing formed by the method of claim 11.
